(19) United States
(12) Patent Application Publication
(10) Pub. No.: US 2026/0017509 A1
(43) Pub. Date: Jan. 15, 2026

(54) Configuration and Generation of Multimodal Embeddings

(71) Applicant: Google LLC, Mountain View, CA (US)

(72) Inventors: Huy Thong Nguyen, Mountain View, CA (US); En-Hung Chu, Mountain View, CA (US); Lenord Melvix Joseph Stephen Max, San Jose, CA (US); Canwen Jiao, Menlo Park, CA (US); Chunglin Wen, New York, NY (US); Benjamin John Louie, Newark, CA (US)

(21) Appl. No.: 18/771,930

(22) Filed: Jul. 12, 2024

(51) Int. Cl. G06N 3/08; G06N 3/045

(52) U.S. Cl. CPC G06N 3/08; G06N 3/045

(57) ABSTRACT

Methods, systems, devices, and non-transitory computer readable media for generating embeddings are provided. The disclosed technology can include receiving multimodal input samples associated with data modalities and labels. The multimodal input samples can comprise topics associated with topics of multimodal input samples. Based on inputting multimodal input samples into modality-specific machine-learned models configured to process data modalities, modality-specific embeddings can be generated. Each multimodal input sample of the multimodal input samples can be inputted into a modality-specific model that is configured to process the data modality associated with the multimodal input sample. The modality-specific embeddings can comprise topic embeddings based on the topics. Based on the plurality of modality-specific embeddings, multimodal machine-learned models can be trained to generate a plurality of common embeddings. Based on inputting the multimodal input samples into the multimodal machine-learned models, the common embeddings can be generated.

### FIELD

The present disclosure relates generally to the configuration and generation of embeddings using machine-learned models. More particularly, the present disclosure relates to using machine-learned models to generate common embeddings based on a plurality of multimodal input samples.

### BACKGROUND

Machine-learning systems may use a variety of different algorithms to perform operations that provide services for users. In particular, large language models (LLMs) have been leveraged to perform operations that involve the use of large datasets. For example, LLMs may be used to perform searches or other types of tasks in which data may be extracted from a large dataset. Further, LLMs may use embeddings that provide a lower dimensionality representation of different types of data such as text or imagery. However, each different type of data may have a different type of embedding that is not compatible with other types of data. Further, searching through different types of data may use a significant amount of computing resources as well as being time consuming. As a result, the effectiveness of services and applications that use embeddings can be impacted by the associated computational expenses involved in using various types of embeddings. Accordingly, there may be different approaches to processing embeddings.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of generating embeddings. The computer-implemented method can comprise receiving, by a computing system comprising one or more processors, a plurality of multimodal input samples associated with a plurality of data modalities and a plurality of labels. The plurality of multimodal input samples can comprise a plurality of topics associated with the plurality of multimodal input samples. The computer-implemented method can comprise generating, by the computing system, based on inputting the plurality of multimodal input samples into a plurality of modality-specific machine-learned models configured to process the plurality of data modalities, a plurality of modality-specific embeddings. Each multimodal input sample of the plurality of multimodal input samples can be inputted into a modality-specific model that is configured to process the data modality associated with the multimodal input sample. The plurality of modality-specific embeddings can comprise a plurality of topic embeddings based on the plurality of topics. The computer-implemented method can comprise training, by the computing system, based on the plurality of modality-specific embeddings, one or more multimodal machine-learned models to generate a plurality of common embeddings. The training can comprise modifying a plurality of parameters of the one or more multimodal machine-learned models to minimize a loss associated with a relevance of the plurality of topic embeddings. Furthermore, the computer-implemented method can comprise generating, by the computing system, based on inputting the plurality of multimodal input samples into the one or more multimodal machine-learned models, the plurality of common embeddings.

Another example aspect of the present disclosure is directed to one or more tangible non-transitory computer-readable media storing computer-readable instructions that when executed by one or more processors cause the one or more processors to perform operations. The operations can comprise receiving a plurality of multimodal input samples associated with a plurality of data modalities and a plurality of labels. The plurality of multimodal input samples can comprise a plurality of topics associated with plurality of multimodal input samples. The operations can comprise generating, based on inputting the plurality of multimodal input samples into a plurality of modality-specific machine-learned models configured to process the plurality of data modalities, a plurality of modality-specific embeddings. Each multimodal input sample of the plurality of multimodal input samples can be inputted into a modality-specific model that is configured to process the data modality associated with the multimodal input sample. The plurality of modality-specific embeddings can comprise a plurality of topic embeddings based on the plurality of topics. The operations can comprise training, based on the plurality of modality-specific embeddings, one or more multimodal machine-learned models to generate a plurality of common embeddings. The training can comprise modifying a plurality of parameters of the one or more multimodal machine-learned models to minimize a loss associated with a relevance of the plurality of topic embeddings. Furthermore, the operations can comprise generating, based on inputting the plurality of multimodal input samples into the one or more multimodal machine-learned models, the plurality of common embeddings.

Another example aspect of the present disclosure is directed to a computing system comprising: one or more processors; one or more non-transitory computer-readable media storing instructions that when executed by the one or more processors cause the one or more processors to perform operations. The operations can comprise receiving a plurality of multimodal input samples associated with a plurality of data modalities and a plurality of labels. The plurality of multimodal input samples can comprise a plurality of topics associated with the plurality of multimodal input samples. The operations can comprise generating, based on inputting the plurality of multimodal input samples into a plurality of modality-specific machine-learned models configured to process the plurality of data modalities, a plurality of modality-specific embeddings. Each multimodal input sample of the plurality of multimodal input samples can be inputted into a modality-specific model that is configured to process the data modality associated with the multimodal input sample. The plurality of modality-specific embeddings can comprise a plurality of topic embeddings based on the plurality of topics. The operations can comprise training, based on the plurality of modality-specific embeddings, one or more multimodal machine-learned models to generate a plurality of common embeddings. The training can comprise modifying a plurality of parameters of the one or more multimodal machine-learned models to minimize a loss associated with a relevance of the plurality of topic embeddings. Furthermore, the operations can comprise generating, based on inputting the plurality of multimodal input samples into the one or more multimodal machine-learned models, the plurality of common embeddings.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that generates common embeddings and trains machine-learning models according to example embodiments of the present disclosure;

FIG. 1B depicts a block diagram of an example computing device that can generate common embeddings and train machine-learning models according to example embodiments of the present disclosure;

FIG. 1C depicts a block diagram of an example computing device that can generate common embeddings and train machine-learning models according to example embodiments of the present disclosure;

FIG. 2 depicts a block diagram of examples of machine-learned models according to example embodiments of the present disclosure;

FIG. 3 depicts an example of a computing device according to example embodiments of the present disclosure;

FIG. 4 depicts an example of processing multimodal input samples according to example embodiments of the present disclosure;

FIG. 5 depicts a flow chart diagram of an example method of generating common embeddings according to example embodiments of the present disclosure;

FIG. 6 depicts a flow chart diagram of an example method of generating search output based on a search query according to example embodiments of the present disclosure; and

FIG. 7 depicts a flow chart diagram of an example method of training machine-learning models according to example embodiments of the present disclosure.

Reference numerals that are repeated across plural figures are intended to identify the same features in various implementations.

### DETAILED DESCRIPTION

In general, the present disclosure is directed to automatically generating embeddings (e.g., dense numerical representations of data associated with images, text, audio, and/or video) that comprise embeddings of multimodal data. In particular, the disclosed technology can generate common embeddings that are based on multiple different types of embeddings that were generated by modality-specific machine-learned models based on modality specific inputs from a plurality of different data modalities (e.g., inputs from a plurality of data modalities including images, text, audio, and/or video). The common embeddings in the disclosed technology can be used to perform a variety of tasks, including information retrieval and/or search (e.g., semantic search).

For example, a computing system can receive a plurality of multimodal input samples associated with a plurality of data modalities and a plurality of labels. The plurality of multimodal input samples can comprise a plurality of topics associated with the plurality of multimodal input samples. For example, the plurality of multimodal input samples can comprise images, audio, and topics that can be associated with the images and audio (e.g., if the images comprise images of birds in the forest, the topics can comprise birds, wildlife, and/or forests). Based on inputting the plurality of multimodal input samples into a plurality of modality-specific machine-learned models configured to process the plurality of data modalities, a plurality of modality-specific embeddings can be generated.

For example, features of the plurality of multi-modal input samples can be processed by the plurality of modality-specific machine-learned models which can generate the modality-specific embeddings which can have a lower dimensionality than the multi-modal input samples on which the modality-specific embeddings are based. Further, the plurality of modality-specific embeddings can comprise a plurality of topic embeddings based on the plurality of topics. The plurality of topic embeddings can later be used to determine the relevance of other types of embeddings.

Each multimodal input sample of the plurality of multimodal input samples can be inputted into a modality-specific model that is configured to process the data modality associated with the multimodal input sample. For example, image samples can be inputted into a modality-specific model that is configured and/or trained to process images. Further, audio samples can be inputted into a modality-specific model that is configured and/or trained to process audio.

Based on the plurality of modality-specific embeddings, one or more multimodal machine-learned models can be trained to generate a plurality of common embeddings. The plurality of common embeddings can comprise a vector space that is based on the plurality of modality-specific embeddings from the different data modalities. For example, the plurality of common embeddings can comprise a vector space that is based on image embeddings, audio embeddings, audio embeddings, video embeddings, and topic embeddings. Training the one or more multimodal machine-learned models can comprise modifying a plurality of parameters of the one or more multimodal machine-learned models to minimize a loss associated with a relevance of the plurality of topic embeddings with respect to the plurality of modality-specific embeddings associated with a data modality not comprising the plurality of topic embeddings. For example, the one or more machine-learned models can be trained over a plurality of iterations until the loss is minimized to some threshold level associated with high accuracy.

Furthermore, based on inputting the plurality of multimodal input samples into the one or more multimodal machine-learned models, the plurality of common embeddings can be generated. The plurality of common embeddings can be used for a variety of tasks including data retrieval and/or searching data (e.g., semantic search). For example, the common embeddings can be used to generate a search index and queries to the search index can retrieve relevant search results from different data modalities. For example, if a user searches for animals performing tricks, the search results can return written stories about horses prancing playfully, images of dogs balancing balls on their heads, audio of cats meowing to music, and/or videos of parrots telling jokes. As such, the disclosed technology allows for improved embeddings and search performance using automatically generated common embeddings based on a plurality of different data modalities.

The disclosed technology can be implemented in a computing system (e.g., an embedding generation computing system) that is configured to access data and/or perform operations on the data. For example, the operations performed by the computing system can comprise receiving a plurality of multimodal input samples, generating a plurality of modality-specific embeddings, training one or more multimodal machine-learned models to generate a plurality of common embeddings, and generating, based on the plurality of multimodal input samples, the plurality of common embeddings.

The computing system can be included as part of a system that includes a server computing device that receives data comprising multimodal input samples from a client computing device, performs operations based on the data and sends output comprising common embeddings back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with the generation of common embeddings that can assist a user in the tasks of search and data retrieval.

The computing system can receive, access, and/or retrieve a plurality of multimodal input samples. The plurality of multimodal input samples can be associated with a plurality of data modalities and/or a plurality of labels. The plurality of data modalities can indicate the type of data that is represented in the plurality of multimodal input samples. Further, the plurality of multimodal input samples can comprise a plurality of images (e.g., color images, greyscale images, and/or black and white images), a plurality of text segments (e.g., words, sentences, and/or paragraphs of text), a plurality of audio segments, a plurality of video segments, and/or a plurality of topics (e.g., topics associated with the plurality of multimodal input samples). In some embodiments, the plurality of multimodal input samples can be formatted to facilitate the training of a machine-learning model. For example, the plurality of multimodal input samples comprising audio segments can be formatted to have the same or similar bitrates.

The plurality of labels can indicate the content of the plurality of multimodal input samples. For example, a multimodal input sample comprising an audio segment of a bird singing can comprise a label indicating “bird singing.” Further, the plurality of labels can comprise a plurality of classes and/or categories associated with the plurality of multimodal input samples. For example, an image of a chocolate cake can be associated with a label indicating that the multimodal input sample is an image of a slice of chocolate cake.

The plurality of multimodal input samples can comprise a plurality of topics associated with the plurality of multimodal input samples. A topic sample of the plurality of topics can indicate one or more topics that are associated with one of the plurality of multimodal input samples. For example, a multimodal input sample that comprises an image of a group of smiling and laughing people eating and drinking together in a restaurant can be associated with the topics “good times,” “enjoyment with friends,” “eating together,” and/or “having fun.”

In some embodiments, the plurality of multimodal input samples can be generated by a plurality of machine-learned input sample generation models comprising a plurality of domain-specific machine-learned models. The plurality of domain-specific models can automatically generate the labels associated with the plurality of multimodal input samples. Further, the plurality of domain-specific machine-learned models can be configured to generate a plurality of confidence scores associated with the plurality of multimodal input samples. Each of the plurality of confidence scores can indicate a probability that a label associated with a multimodal input sample is accurate. Further, the plurality of multimodal input samples can be configured to generate a plurality of multimodal input samples comprising a plurality of topics associated with a plurality of modality-specific input samples (e.g., topics associated with images, audio segments, text segments, and/or video segments).

The computing system can generate a plurality of modality-specific embeddings. The plurality of modality-specific embeddings can comprise a plurality of representations (e.g., numerical representations) of the plurality of multimodal input samples. Further, the plurality of modality-specific embeddings can comprise a plurality of vectors that have a lower dimensionality than the plurality of multimodal input samples on which the plurality of modality-specific embeddings are based. Each modality-specific embedding of the plurality of modality-specific embeddings can comprise a representation of a particular modality of the input sample. For example, a portion of the plurality of modality-specific embeddings can be based on the plurality of multimodal input samples comprising image samples and another mutually exclusive portion of the plurality of modality-specific embeddings can be based on the plurality of multimodal input samples comprising audio samples.

Generating the plurality of modality-specific embeddings can be based on inputting the plurality of multimodal input samples into a plurality of modality-specific machine-learned models configured to process the plurality of data modalities. Each multimodal input sample of the plurality of multimodal input samples can be inputted into a modality-specific model that is configured to process the data modality associated with the multimodal input sample. For example, if the plurality of modality-specific machine-learned models comprise a first modality-specific machine-learned model that is configured and/or trained to process image samples and a second modality-specific machine-learned model that is configured and/or trained to process audio samples, the plurality of multimodal input samples comprising image samples can be inputted into the first modality-specific machine-learned model and the plurality of multimodal input samples comprising audio samples can be inputted into the second modality-specific machine-learned model.

The plurality of modality-specific embeddings can comprise a plurality of topic embeddings based on the plurality of topics. The plurality of topic embeddings can comprise a plurality of embeddings comprising a lower dimensionality than the plurality of topics on which the plurality of modality-specific embeddings are based. In some embodiments, the plurality of modality-specific machine-learned models can comprise a topic encoder that is configured to generate the plurality of topic embeddings based on the plurality of topics. The topic encoder can be configured and/or trained to generate a plurality of representations of the plurality of topics that are arranged in a vector space such that the distance (e.g., Euclidean distance or cosine distance) between representations of topics in the vector space is positively correlated with the similarity of the topics. The representation of topics that are similar can be closer together in the vector space than the representation of topics that are dissimilar. For example, topics associated with weddings can be represented in the vector space as being close to similar topics associated with weddings such as wedding rings, wedding cakes, and/or wedding dresses. Further, topics associated with weddings can be represented in the vector space as being far from dissimilar topics such as deep-water fishing, the sport of rowing, and/or coal mining.

In some embodiments, the plurality of multimodal input samples can comprise a plurality of images and/or the plurality of modality-specific machine-learned models can comprise an image encoder that is configured to generate a plurality of image embeddings based on detecting or recognizing visual features of the plurality of multimodal input samples comprising the plurality of images. The image encoder can be configured and/or trained to generate a plurality of representations of the plurality of images that are arranged in a vector space such that the distance between representations of images in the vector space is positively correlated with the similarity of the images. The representation of images that are similar can be closer together in the vector space than the representation of images that are dissimilar. For example, images associated with cats can be represented in the vector space as being close to similar images associated with cat food and/or cat toys. Further, images associated with cats can be represented in the vector space as being far from dissimilar images associated with power tools or highways. Further, the plurality of modality-specific embeddings can comprise the plurality of image embeddings.

In some embodiments, the plurality of multimodal input samples can comprise a plurality of text segments and/or the plurality of modality-specific machine-learned models can comprise a text encoder that is configured to generate a plurality of text embeddings based on detecting or recognizing semantic features of the plurality of multimodal input samples comprising the plurality of text segments. The text encoder can be configured and/or trained to generate a plurality of representations of the plurality of text segments that are arranged in a vector space such that the distance between representations of text segments in the vector space is positively correlated with the similarity of the text segments. The representation of text segments that are similar can be closer together in the vector space than the representation of text segments that are dissimilar. For example, text segments associated with Neonatal medical research can be represented in the vector space as being close to similar text segments associated with pediatric research and/or medical research. Further, text segments associated with neonatal medical research can be represented in the vector space as being far from dissimilar text segments associated with English poetry or highway management. Further, the plurality of modality-specific embeddings can comprise the plurality of text embeddings.

In some embodiments, the plurality of multimodal input samples can comprise a plurality of audio segments and/or the plurality of modality-specific machine-learned models can comprise an audio encoder that is configured to generate a plurality of audio segments embeddings based on detecting or recognizing audio features of the plurality of multimodal input samples comprising the plurality of audio segments. The audio encoder can be configured and/or trained to generate a plurality of representations of the plurality of audio segments that are arranged in a vector space such that the distance between representations of audio segments in the vector space is positively correlated with the similarity of the audio segments. The representation of audio segments that are similar can be closer together in the vector space than the representation of audio segments that are dissimilar. For example, audio segments associated with the music of Johann Sebastian Bach can be represented in the vector space as being close to similar audio segments associated with the music of other Baroque composers. Further, audio segments associated with the music of Johann Sebastian Bach can be represented in the vector space as being far from dissimilar audio segments associated with dogs barking or audio transcripts of a court case. Further, the plurality of modality-specific embeddings can comprise the plurality of audio segments embeddings.

In some embodiments, the plurality of multimodal input samples can comprise a plurality of video segments and/or the plurality of modality-specific machine-learned models can comprise a video encoder that is configured to generate a plurality of video segments embeddings based on detecting or recognizing video features of the plurality of multimodal input samples comprising the plurality of video segments. The video encoder can be configured and/or trained to generate a plurality of representations of the plurality of video segments that are arranged in a vector space such that the distance between representations of video segments in the vector space is positively correlated with the similarity of the video segments. The representation of video segments that are similar can be closer together in the vector space than the representation of video segments that are dissimilar. For example, video segments associated with piano performances can be represented in the vector space as being close to similar video segments associated with harpsichord performances and/or electronic keyboard performances. Further, video segments associated with piano performances can be represented in the vector space as being far from dissimilar video segments associated with cycling or swimming. Further, the plurality of modality-specific embeddings can comprise the plurality of video segment embeddings.

In some embodiments, the plurality of modality-specific machine-learned models can comprise a plurality of transformer models that are configured to generate the plurality of modality-specific embeddings based on the plurality of multimodal input samples. Further, the plurality of modality-specific machine-learned models can comprise one or more large language models (LLMs). The one or more LLMs can be configured and/or trained to generate output comprising topic embeddings and/or text embeddings based on input comprising the plurality of multimodal input samples.

The computing system can configure and/or train one or more multimodal machine-learned models to generate a plurality of common embeddings. Training the one or more multimodal machine-learned models can comprise modifying a plurality of parameters of the one or more multimodal machine-learned models to minimize a loss associated with a relevance of the plurality of topic embeddings. For example, training the one or more multimodal machine-learned models can comprises modifying a plurality of parameters of the one or more multimodal machine-learned models to minimize a loss associated with a relevance with respect to the other modality-specific embeddings of the plurality of modality-specific embeddings which can include other modality-specific embeddings that have a different data modality.

Training the one or more multimodal machine-learned models can comprise determining, based on inputting training data comprising the plurality of common embeddings and the plurality of topic embeddings into the one or more multimodal machine-learned models, a plurality of relevance scores based on comparing the plurality of topic embeddings to the plurality of modality-specific embeddings associated with another one of the plurality of data modalities. The plurality of relevance scores can be associated with a relevance and/or similarity of a modality-specific embedding with respect to another modality-specific embedding that has a different data modality. Further, the plurality of relevance scores can be associated with a relevance and/or similarity of a modality-specific embedding with respect to the plurality of topic embeddings. Each of the plurality of relevance scores can indicate an extent to which an embedding is similar to another embedding associated with a different data modality. For example, a (high) relevance score of 0.98 on a scale of 0.0 to 1.0 can indicate a 98% relevance and/or similarity to another embedding (e.g., the embedding is associated with another similar embedding).

By way of further example, a (low) relevance score of 0.25 on a scale of 0.0 to 1.0 can indicate a 25% relevance and/or similarity to another embedding (e.g., the embedding is associated with a dissimilar embedding). For example, an embedding of a tiger can have a high relevance score with respect to a lion embedding or a leopard embedding and can have a low relevance score with respect to a helicopter embedding or a motorcycle embedding. Further, based on the relevance score for a pair of embeddings being close to 1.0 (e.g., a relevance score of 0.96 which can indicate that the pair of embeddings are highly relevant and/or similar to one another) the one or more multimodal machine-learned models can be configured and/or trained to embed the pair of embeddings in the plurality of common embeddings. Based on the relevance score for a pair of embeddings being close to 0.0 (e.g., a relevance score of 0.12 which can indicate that the pair of embeddings are not relevant and/or similar to one another) the one or more multimodal machine-learned models can be configured and/or trained to orthogonally embed the pair of embeddings in the plurality of common embeddings.

After each of the plurality of iterations, a loss associated with the accuracy of the output generated by the one or more multimodal machine-learned models can be generated (e.g., a loss that is inversely correlated with the accuracy of the output of the one or more multimodal machine-learned models). The weights of the parameters that contribute to decreasing the loss can be increased and the weights of the parameters that do not contribute to decreasing the loss or that increase the loss can be decreased. The one or more multimodal machine-learned models can be trained until some threshold accuracy level (e.g., 0.98 on a scale of 0.0 to 1.0 in which 1.0 is the highest accuracy and 0.0 is the lowest accuracy) is achieved.

Further, training the one or more multimodal machine-learned models can comprise determining a loss based on the plurality of relevance scores. The loss can be inversely proportional to an accuracy of the plurality of relevance scores generated by the one or more multimodal machine-learned models. The loss can be associated with the accuracy of the plurality of relevance scores generated by the one or more multimodal machine-learned models. A low loss (e.g., a low loss value) can be associated with a high accuracy of the plurality of relevance scores. A high loss (e.g., a high loss value) can be associated with a low accuracy of the plurality of relevance scores.

The plurality of relevance scores can comprise a plurality of predicted relevance scores and/or a plurality of ground-truth relevance scores (e.g., ground-truth relevance scores can be associated with an actual similarity and/or relevance between a topic embedding and another type of modality-specific embedding). The loss can increase in proportion to the number of the one or more differences between a plurality of predicted relevance scores and the plurality of ground-truth relevance scores. For example, if there are five differences between the plurality of predicted relevance scores and the plurality of ground-truth relevance scores, the loss can be greater than if there is one difference between the plurality of predicted relevance scores and the plurality of ground-truth relevance scores.

Further, the loss can increase in proportion to the magnitude of differences between the plurality of predicted relevance scores and the plurality of ground-truth relevance scores. For example, a predicted relevance score that is slightly different from a ground-truth relevance score can result in a smaller loss than a predicted relevance score that is significantly different from a ground-truth relevance score. The loss can increase when an irrelevant embedding is determined to be relevant and/or a relevant embedding is determined to be irrelevant. The loss can decrease when a relevant embedding is determined to be relevant and/or an irrelevant embedding is determined to be irrelevant. A loss function can be used to determine the loss. Further, the loss function can be used to evaluate the plurality of relevance scores.

In some embodiments, training the one or more multimodal machine-learned models can comprise determining a dot product of the plurality of common embeddings. For example, the dot product of the plurality of topic embeddings and the plurality of modality-specific embeddings based on the plurality of multimodal input samples comprising image samples can be used to determine the similarity and/or relevance (e.g., relevance score) of the plurality of modality-specific embeddings with respect to the plurality of topic embeddings.

Training the one or more multimodal machine-learned models can comprise modifying the plurality of parameters of the one or more multimodal machine-learned models to minimize the loss. The plurality of parameters can be associated with a plurality of weights that indicate an extent to which the plurality of parameters contribute to reducing and/or minimizing a loss (e.g., a loss that is inversely correlated with the accuracy of the output generated by the one or more multimodal machine-learned models). For example, the one or more multimodal machine-learned models can be trained to generate common embeddings and can comprise a plurality of parameters that are modified over a plurality of iterations in which the plurality of modality-specific embeddings are inputted into the one or more multimodal machine-learned models. The loss can be inversely correlated with the relevance scores such that embeddings that are more dissimilar contribute to increasing the loss and embeddings that are similar contribute to reducing the loss.

Training the machine-learned model can be performed over a plurality of iterations. In each iteration of training, the weights of the parameters that contribute to increasing the loss can be reduced, the weights of the parameters that do not contribute to increasing or decreasing the loss can be kept unmodified, and/or the weights of the parameters that contribute to decreasing the loss can be increased. As a result, the plurality of weights of the plurality of parameters can be positively correlated with the loss such that parameters that are more heavily weighted can contribute more to determining the relevance scores than parameters that are less heavily weighted. Over the plurality of iterations, the loss can be minimized until a threshold loss that corresponds to a high accuracy of the machine-learned model determining the plurality of relevance scores is achieved. For example, the loss can be minimized until a threshold loss associated with 98% accuracy is achieved by the machine-learned model.

The computing system can generate a plurality of common embeddings. Generating the plurality of common embeddings can be based on inputting the plurality of multimodal input samples into the one or more multimodal machine-learned models. The one or more multimodal machine-learned models can be configured and/or trained to receive various multimodal input samples and generate common embeddings that extract features of the various multimodal input samples and arrange those features in a vector space that has a lower dimensionality than the dimensionality of the multimodal input samples. For example, the plurality of common embeddings can be generated based on a plurality of image samples and the plurality of topics. By way of further example, the plurality of common embeddings can be generated based on audio samples and the plurality of topic embeddings.

In some embodiments, training the one or more multimodal machine-learned models can comprise generating, based on the plurality of modality-specific embeddings, a plurality of normalized modality-specific embeddings. normalizing the plurality of modality-specific embeddings. Normalizing the plurality of modality-specific embeddings can comprise generating a plurality of normalized modality-specific embeddings which can comprise modifying the dimensionality of the vectors of the plurality of modality-specific embeddings to be equal in size. For example, if the plurality of modality-specific embeddings have dimensionalities ranging from 100 dimensions to 800 dimensions, the computing system can normalize the dimensionality of the plurality of modality-specific embeddings to 800 dimensions.

The computing system can generate a search index. Generating the search index can be based on processing the plurality of common embeddings. Further, the search index can comprise the plurality of common embeddings. The search index can be configured to generate search output associated with one or more of the plurality of data modalities. The search output can comprise one or more images, one or more text segments, one or more audio segments, one or more video segments, and/or one or more topics. In some embodiments, the search index can be searched based on the use of a search algorithm that can be used to search the plurality of common embeddings. For example, the search algorithm can comprise a nearest neighbor algorithm (e.g., k-nearest neighbor algorithm or a scalable nearest neighbor algorithm) and/or a hashing algorithm (e.g., locality-sensitive hashing). In some embodiments, a brute force approach can be used to search the plurality of common embeddings.

The computing system can receive a search query. For example, the computing system can receive a search query associated with finding a Chinese restaurant in a particular city (e.g., Chicago). The search query can comprise a text-based search query (e.g., a query provided in the form of text), a navigational query (e.g., a query associated with navigation), an audio-based query (e.g., a query provided in the form of audio such as a spoken query), and/or an image-based query (e.g., a search query provided in the form of an image such an image of an article of clothing to be identified and for which a price of the identified article of clothing is determined). A navigational query can comprise a query for a location and/or address associated with the navigational query. For example, the navigational query “FIND A GOOD CHINESE RESTAURANT THAT HAS QUICK SERVICE AND IS NOT TOO EXPENSIVE.” can be used to search the search index for locations of restaurants (e.g., locations associated with reviews that indicate attributes of the locations including the type of restaurant, quickness of service, and/or price range) that meet the search criteria (e.g., good Chinese food, quick service, and not too expensive). The locations indicated in the plurality of common embeddings can comprise geographic coordinates that can be used to generate navigational instructions to travel to the location (e.g., the location of the Chinese restaurant). By way of further example, the navigational query “WHAT ARE THE NICE WALKING TRAILS AROUND HERE?” can be used to search the search index for locations of walking trails or parks (e.g., locations associated with reviews that indicate attributes of the locations including the type of park, user reviews of the safety of the location, aesthetic qualities of the location, and/or the proximity of the location) that meet the search criteria (e.g., nice, walking trail, and around here (in close proximity to the source of the search request)). In some embodiments, the computing system can generate a common embedding based on the search query. The common embedding based on the search query can be used to search the plurality of common embeddings for the plurality of common embeddings that are similar to the common embedding based on the search query.

The computing system can generate search output based on comparing the search query to the plurality of common embeddings included in the search index. Further, the search output can be associated with a plurality of different data modalities. For example, a search embedding can be generated based on the search query. For example, the search query can be inputted into the one or more multimodal machine-learned models that can be configured to generate a common embedding based on the search query. The common embedding based on the search query can be compared to the plurality of common embeddings to determine relevant and/or similar embeddings that are associated with the search embedding. For example, based on finding common embeddings that are similar to the common embedding based on a search query associated with finding Chinese restaurants in Chicago, the search output can comprise a listing of Chinese restaurants in the city of Chicago along with images of the restaurants and video reviews of the restaurants. Further, the search output for search queries comprising navigational queries can comprise one or more locations and/or one or more directions associated with the navigational queries (e.g., a navigational query for walking trails can comprise the location of walking trails and/or directions the navigational trails).

The systems, methods, devices, apparatuses, and tangible non-transitory computer-readable media in the disclosed technology can provide a variety of technical effects and benefits including improving the efficiency of resource utilization and improving the performance of computing systems. In particular, the disclosed technology can improve the efficiency of resource utilization by consolidating embeddings based on different data modalities into a common embedding that can be used across the different data modalities. This consolidation of embeddings can reduce storage requirements for embeddings as well as improving the efficiency of computational resource use. For example, a single embedding can be used to perform retrieval tasks across different media (e.g., images, text, audio, and/or video) instead of using multiple different embeddings. Further, the improved use of computational resources can reduce the amount of energy consumed in processing embeddings by a computing system. Further, the more efficient common embeddings can reduce the amount of heat produced in processing embeddings, which can result in environmental benefits such as reduced energy and water usage for cooling.

Further, the disclosed technology can improve the performance of computing systems by generating common embeddings that can result in improved search performance. The common embeddings can provide more comprehensive search results. Further, the common embeddings can have impose a lower computational burden and be used on computing systems that have relatively lower computational power, thereby allowing a greater number of computing systems to leverage the various uses of machine-learning systems that use embeddings (e.g., LLMs).

As such, the disclosed technology may assist the user of a machine-learning system (e.g., an LLM) in more effectively performing a variety of tasks with the specific benefits of improving the efficiency of resource utilization and improved computational performance. Further, any of the specific benefits provided to users can be used to improve the effectiveness of a wide variety of devices and services including computing devices and/or machine-learning applications. Accordingly, the improvements offered by the disclosed technology can result in tangible benefits to a variety of devices and/or systems including mechanical, electronic, and computing systems that can leverage the benefits of common embeddings.

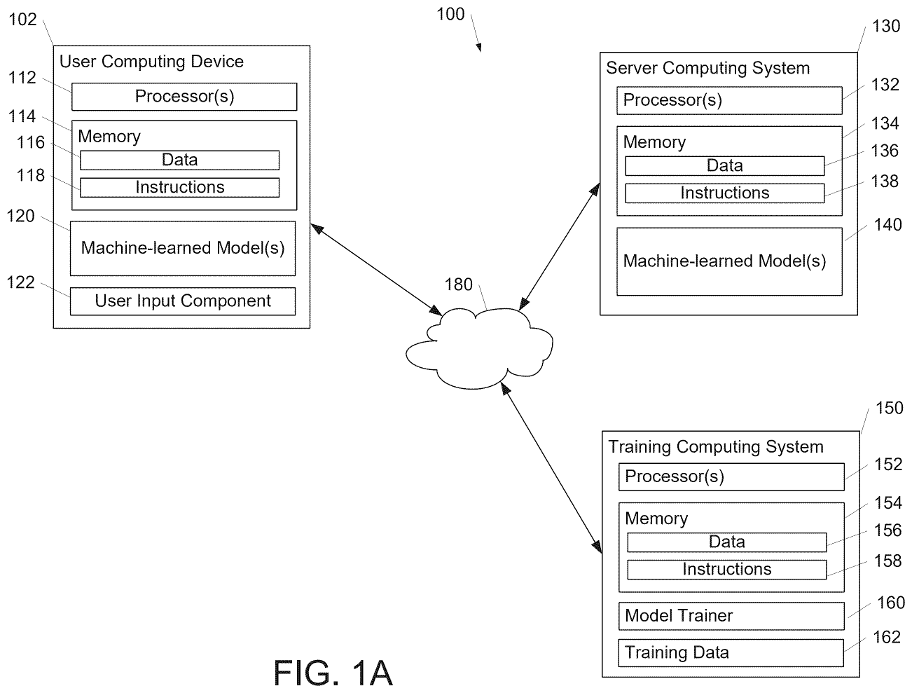

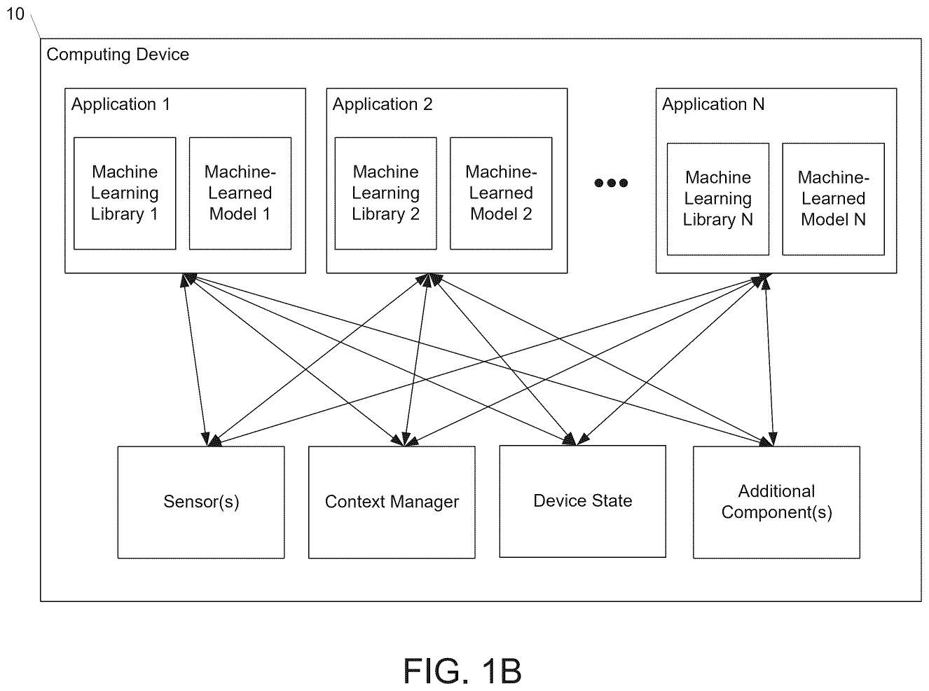

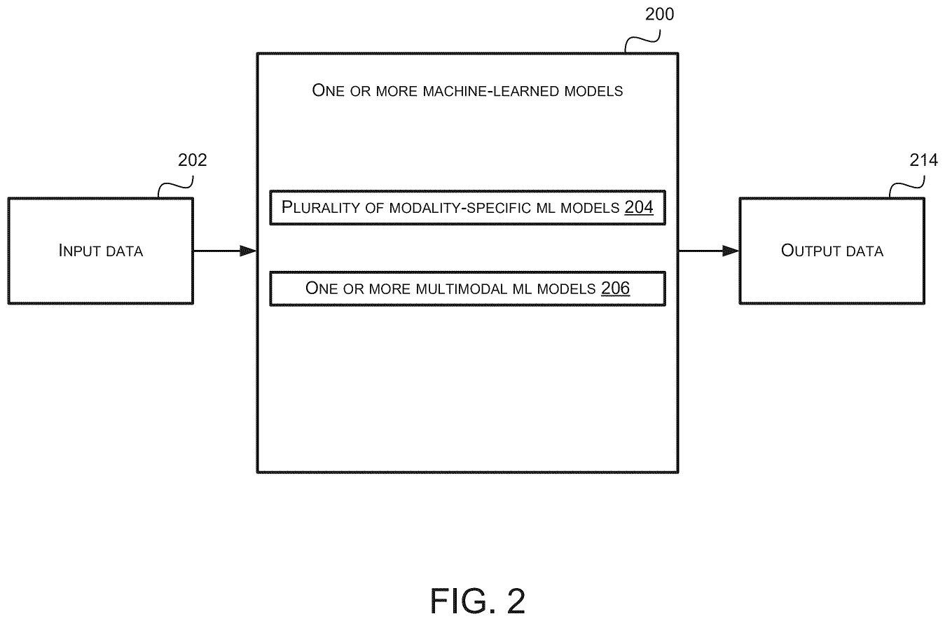

With reference now to the figures, example embodiments of the present disclosure will be discussed in further detail. FIG. 1A depicts a block diagram of an example computing system that can generate common embeddings and train machine-learning models according to example embodiments of the present disclosure. System 100 includes a computing device 102, a server computing system 130, and a training computing system 150 that are communicatively coupled over a network 180.

The computing device 102 can comprise any type of computing device, including, for example, a personal computing device (e.g., laptop computing device or desktop computing device), a mobile computing device (e.g., smartphone or tablet), a gaming console or controller, an embedded computing device, a wearable computing device (e.g., a smartwatch), or any other type of computing device.

The computing device 102 includes one or more processors 112 and a memory 114. The one or more processors 112 can comprise any suitable processing device (e.g., a processor core, a microprocessor, an ASIC, an FPGA, a controller, and/or a microcontroller) and can comprise one processor or a plurality of processors that are operatively connected. The memory 114 can include one or more non-transitory computer-readable storage media, such as RAM, ROM, EEPROM, EPROM, flash memory devices, magnetic disks, and/or combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, comprising non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Examples of one or more machine-learned models 120 are discussed with reference to FIGS. 1-7.

In some implementations, the one or more machine-learned models 120 can be received from the server computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel common embedding generation operations across multiple instances of the one or more machine-learned models 120).

More particularly, the one or more machine-learned models 120 can comprise one or more machine-learned models (e.g., one or more multimodal machine-learned models and/or one or more modality-specific models) that are configured and/or trained to perform operations comprising receiving a plurality of multimodal input samples, generating a plurality of modality-specific embeddings, training one or more multimodal machine-learned models to generate a plurality of common embeddings, and/or generating, based on the plurality of multimodal input samples, the plurality of common embeddings.

Additionally or alternatively, one or more machine-learned models 140 (e.g., one or more multimodal machine-learned models and/or one or more modality-specific models) can be included in or otherwise stored and implemented by the server computing system 130 that communicates with the computing device 102 according to a client-server relationship. For example, the one or more machine-learned models 140 can be implemented by the server computing system 130 as a portion of a web service (e.g., a common embeddings generation service, a search service that uses common embeddings, and/or a machine-learned model training service). Thus, one or more machine-learned models 120 can be stored and implemented at the computing device 102 and/or one or more machine-learned models 140 can be stored and implemented at the server computing system 130.

The computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, and/or a microcontroller) and can be one processor or a plurality of processors that are operatively connected. The memory 134 can include one or more non-transitory computer-readable storage media, such as RAM, ROM, EEPROM, EPROM, flash memory devices, magnetic disks, and/or combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Examples of one or more machine-learned models 140 are discussed with reference to FIGS. 1-7.

The computing device 102 and/or the server computing system 130 can train the one or more machine-learned models 120 and/or the one or more machine-learned models 140 via interaction with the training computing system 150 that can be communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, and/or a microcontroller) and can be one processor or a plurality of processors that are operatively connected. The memory 154 can include one or more non-transitory computer-readable storage media, such as RAM, ROM, EEPROM, EPROM, flash memory devices, magnetic disks, and/or combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the one or more machine-learned models 120 and/or the one or more machine-learned models 140 stored at the computing device 102 and/or the server computing system 130 using various training or learning techniques (e.g., machine-learning techniques), such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a plurality of training iterations.

In some implementations, performing backwards propagation of errors can include performing truncated backpropagation through time. The model trainer 160 can perform a number of generalization techniques (e.g., weight decays, dropouts, and/or other generalization techniques.) to improve the generalization capability of the models being trained.

In particular, the model trainer 160 can train the one or more machine-learned models 120 and/or the one or more machine-learned models 140 based on a set of training data 162. The training data 162 can include various types of data. For example, the training data 162 can include a plurality of multimodal input samples (e.g., images, text segments, audio segments, and/or video segments) that can be associated with a plurality of labels. For example, the training data 162 can comprise a plurality of images of animals and the associated labels (e.g., the type of animal such as “cat” for an image of a cat). The training data 162 can also comprise ground-truth labels associated with the plurality of multimodal input samples in the training data 162. Further, the training data 162 can include various publications (e.g., books, articles, and/or journals) that can be received from a variety of sources including libraries, the Internet (e.g., websites), and/or devices that can comprise sensors and can be configured to generate and/or receive data (e.g., smartphones, smartwatches, and/or other computing devices that can be configured to receive sensor data and/or data entered by a user). The model trainer 160 can train and/or retrain the one or more machine-learned models 120 and/or the one or more machine-learned models 140 based on additional data from the training data 162 which can comprise additional multimodal input samples (e.g., updated input samples), new types of multimodal input samples (e.g., new types of multimodal input sample data based on sensor data from new sensor types), and/or one or more modifications to existing multimodal input samples.

In some implementations, if a user has provided consent (e.g., the user provides affirmative consent for another party to use the user's image data), the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM, hard disk, or optical or magnetic media.

The network 180 can comprise any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can be text or natural language data. The machine-learned model(s) can process the text or natural language data to generate an output (e.g., based on inputting queries from a user the machine-learned model(s) can process and generate an analysis comprising one or more explanations and visualizations associated with the queries and image data of the user). As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can comprise speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can comprise latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can comprise statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can comprise sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio data or visual data).

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example computing device that can generate common embeddings and train machine-learning models according to example embodiments of the present disclosure. A computing device 10 can be a user computing device or a server computing device.

The computing device 10 can include a number of applications (e.g., applications 1 through N). Each application contains its own machine-learned library and machine-learned model(s). For example, each application can include a machine-learned model. Example applications include a multimodal input sample processing application, a modality-specific embedding generation application, a common embedding generation application, a machine-learned model training application, a messaging application, a dictation application, and/or a browser application.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that can generate common embeddings and train machine-learning models according to example embodiments of the present disclosure. A computing device 50 can be a user computing device or a server computing device.

The computing device 50 can include a number of applications (e.g., applications 1 through N). Each application is in communication with a central intelligence layer. Example applications include an input processing application (e.g., an application that is configured to process multimodal input samples and generate embeddings including modality-specific embeddings and/or common embeddings), a search application (e.g., an application that is configured to search common embeddings based on a search query), a machine-learned model training application (e.g., an application that is used to train machine-learned models based on multimodal input samples and/or embeddings), a messaging application, and/or a browser application. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

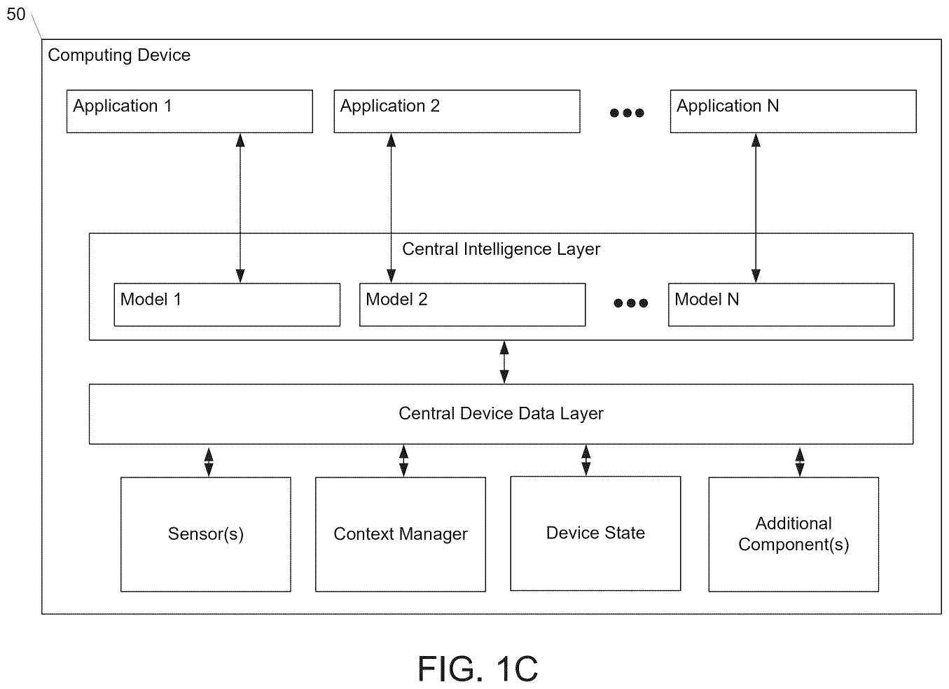

FIG. 2 depicts a block diagram of examples of machine-learned models according to example embodiments of the present disclosure. In some implementations, the one or more machine-learned models 200 can be trained to receive input data 202 that can comprise a plurality of multimodal input samples associated with a plurality of labels. As a result of receiving the input data 202 the one or more machine-learned models 200 can generate output data 214 that can comprise a plurality of common embeddings.

In some implementations, the one or more machine-learned models 200 can include a plurality of modality-specific models 204 (e.g., a plurality of modality-specific models each of which is configured and/or trained using training data that includes input samples from a single data modality) that is operable to generate the plurality of modality-specific embeddings. Further, the one or more machine-learned models 200 can include one or more multimodal machine-learned models 206 (e.g., a multimodal modal that is configured and/or trained using a wide variety of training data that includes input samples from different data modalities) that is operable to generate output data 214 which can comprise a plurality of common embeddings.

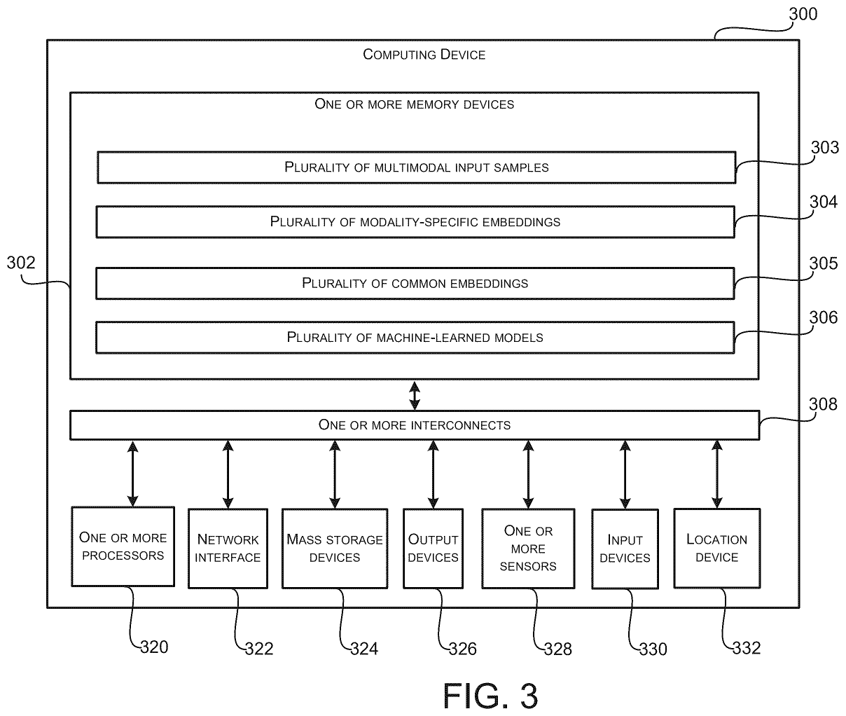

FIG. 3 depicts an example of a computing device according to example embodiments of the present disclosure. A computing device 300 can include one or more features and/or capabilities of the computing device 102, the server computing system 130, and/or the training computing system 150. Furthermore, the computing device 300 can perform one or more actions and/or operations performed by the computing device 102, the server computing system 130, and/or the training computing system 150, which are described with respect to FIG. 1A.

As shown in FIG. 3, the computing device 300 can include one or more memory devices 302, a plurality of multimodal input samples 303, a plurality of modality-specific embeddings 304, a plurality of common embeddings 305, a plurality of machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., data comprising the plurality of modality-specific embeddings 304, and/or the plurality of common embeddings 305) based on a plurality of multimodal input samples 303 (e.g., images, text segments, audio segments, and/or video segments) which can include local data stored in the one or more memory devices 302 and/or data received from another computing device or computing system (e.g., a remote computing system).

The one or more memory devices 302 can store information and/or data (e.g., the plurality of multimodal input samples 303, the plurality of modality-specific embeddings 304, the plurality of common embeddings 305, and/or the plurality of machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including operations associated with receiving a plurality of multimodal input samples, generating a plurality of modality-specific embeddings, training one or more multimodal machine-learned models to generate a plurality of common embeddings, and generating, based on the plurality of multimodal input samples, the plurality of common embeddings.

The plurality of multimodal input samples 303 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. In some embodiments, the plurality of multimodal input samples 303 can be received from one or more computing systems (e.g., the server computing system 130 that is depicted in FIG. 1) which can include one or more computing systems that are remote (e.g., in another building) from the computing device 300.

The plurality of modality-specific embeddings 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the plurality of modality-specific embeddings 304 can include information associated with the plurality of multimodal input samples 303 (e.g., embeddings based on images, text segments, video segments, audio segments, and/or topics). In some embodiments, the plurality of modality-specific embeddings 304 can be received from one or more computing systems (e.g., the server computing system 130 that is depicted in FIG. 1) which can include one or more computing systems that are remote from the computing device 300.

The plurality of common embeddings 305 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the plurality of common embeddings 305 can include information associated with the plurality of modality-specific embeddings 304. In some embodiments, the plurality of common embeddings 305 can be received from one or more computing systems (e.g., the server computing system 130 that is depicted in FIG. 1) which can include one or more computing systems that are remote from the computing device 300.

The plurality of machine-learned models 306 (e.g., the one or more machine-learned models 120, the one or more machine-learned models 140, and/or the machine-learned models 200) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the plurality of machine-learned models 306 can be configured to receive the plurality of multimodal input samples 303 and generate the plurality of modality-specific embeddings 304 and/or the plurality of common embeddings 305. In some embodiments, the plurality of machine-learned models 306 can be received from one or more computing systems (e.g., the server computing system 130 that is depicted in FIG. 1) which can include one or more computing systems that are remote from the computing device 300.

The one or more interconnects 308 can include one or more interconnects or buses that can be used to send and/or receive one or more signals (e.g., electronic signals) and/or data (e.g., the plurality of multimodal input samples 303, the plurality of modality-specific embeddings 304, and/or the plurality of machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the plurality of multimodal input samples 303, the plurality of modality-specific embeddings 304, the plurality of common embeddings 305, and/or the plurality of machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., the plurality of multimodal input samples 303, the plurality of modality-specific embeddings 304, the plurality of common embeddings 305, and/or the plurality of machine-learned models 306) from other computing devices. The one or more mass storage devices 324 (e.g., a hard disk drive and/or a solid-state drive) can be used to store data including the plurality of multimodal input samples 303, the plurality of modality-specific embeddings 304, the plurality of common embeddings 305, and/or the plurality of machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on images associated with the plurality of multimodal input samples 303, the plurality of modality-specific embeddings 304, the plurality of common embeddings 305, and/or the plurality of machine-learned models 306.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which may be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including the plurality of multimodal input samples 303, the plurality of modality-specific embeddings 304, the plurality of common embeddings 305, and/or the plurality of machine-learned models 306. The one or more memory devices 302 can be used to operate various applications including a mobile operating system developed specifically for mobile devices. As such, the one or more memory devices 302 can store instructions that allow the software applications to access data including data associated with the plurality of multimodal input samples 303, the plurality of modality-specific embeddings 304, the plurality of common embeddings 305, and/or the plurality of machine-learned models 306. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

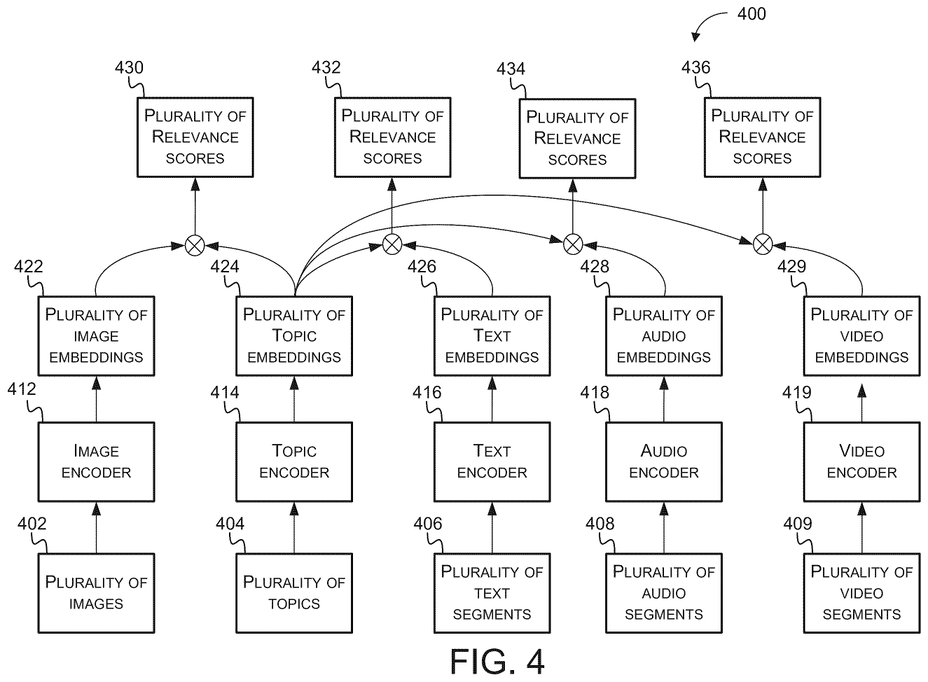

FIG. 4 depicts an example of a computing system comprising machine-learned models configured to process multimodal input samples according to example embodiments of the present disclosure. A computing system 400 can include one or more features and/or capabilities of the computing device 102, the server computing system 130, the training computing system 150, and/or the computing device 300. Furthermore, the computing system 400 can perform one or more actions and/or operations that can be performed by the computing device 102, the server computing system 130, the training computing system 150, and/or the computing device 300. The computing system comprises a plurality of images 402, a plurality of topics 404, a plurality of text segments 406, a plurality of audio segments 408, a plurality of video segments 409, an image encoder 412, a topic encoder 414, a text encoder 416, an audio encoder 418, a video encoder 419, a plurality of image embeddings 422, a plurality of topic embeddings 424, a plurality of text embeddings 426, a plurality of audio embeddings, a plurality of video embeddings, a plurality of relevance scores 430, a plurality of relevance scores 432, a plurality of relevance scores 434, and/or a plurality of relevance scores 436.

In FIG. 4, a plurality of multimodal input samples can comprise a plurality of images 402, a plurality of topics 404, a plurality of text segments 406 that are associated with a plurality of labels. The plurality of multimodal input samples can be processed by the plurality of modality-specific machine-learned models comprising the image encoder 412, the topic encoder 414, the text encoder 416, the audio encoder, and/or the video encoder.

The image encoder 412 can comprise a modality-specific machine-learned model that is configured and/or trained to receive the plurality of images 402 and generate the plurality of image embeddings 422, based on the plurality of images 402. The topic encoder 414 can comprise a modality-specific machine-learned model that is configured and/or trained to receive the plurality of topics 404 and generate the plurality of topic embeddings 424, based on the plurality of topics 404. The text encoder 416 can comprise a modality-specific machine-learned model that is configured and/or trained to receive the plurality of text segments 406 and generate the plurality of text embeddings 426, based on the plurality of text segments 406. The audio encoder 418 can comprise a modality-specific machine-learned model that is configured and/or trained to receive the plurality of audio segments 408 and generate the plurality of audio embeddings 428, based on the plurality of audio segments 408. The video encoder 419 can comprise a modality-specific machine-learned model that is configured and/or trained to receive the plurality of video segments 409 and generate the plurality of video embeddings 429, based on the plurality of video segments 409.

In this example, a plurality of relevance scores 430 can be generated based on a comparison of the plurality of image embeddings 422 to the plurality of topic embeddings 424. In some embodiments, the plurality of relevance scores 430 can be based on a dot product of an image embedding of the plurality of image embeddings 422 and a topic embedding of the plurality of topic embeddings 424. In some embeddings, the plurality of relevance scores 430 can be based on a Euclidean distance between an image embedding of the plurality of image embeddings 422 and a topic embedding of the plurality of topic embeddings 424. Further, the plurality of relevance scores 430 can be based on a cosine similarity of an image embedding of the plurality of image embeddings 422 with respect to a topic embedding of the plurality of topic embeddings 424.

For example, the plurality of topic embeddings 424 can comprise topic embeddings that are associated with university admissions (e.g., the rankings of various universities, the academic programs of universities, and/or the amenities of universities). The topic embeddings associated with university admissions topics can be compared to an image embedding of the plurality of image embeddings 422 that is associated with a review of an aquarium (e.g., images of the aquarium and the various aquatic life in the aquarium) that is not similar to the topic embedding (e.g., university admissions topics). The relevance score for an image embedding that is not similar to a particular topic embedding can be lower than a relevance score for another image embedding that is more similar to the same topic embedding. For example, if the image embedding of the plurality of image embeddings 422 was associated with images of university buildings and university professors instead of images of aquariums, the relevance score would be higher due to images of universities being more relevant to university admissions topics than images of aquariums. The plurality of relevance scores 430 can be used to configure and/or train one or more multimodal machine-learned models to generate common embeddings in which a plurality of modalities are embedded in an embedding.

Further, a plurality of relevance scores 432 can be generated based on a comparison of the plurality of text embeddings 426 to the plurality of topic embeddings 424. In some embodiments, the plurality of relevance scores 432 can be based on a dot product of a text embedding of the plurality of text embeddings 426 and a topic embedding of the plurality of topic embeddings 424. In some embeddings, the plurality of relevance scores 432 can be based on a Euclidean distance between text embedding of the plurality of text embeddings 426 and a topic embedding of the plurality of topic embeddings 424. Further, the plurality of relevance scores 432 can be based on a cosine similarity of a text embedding of the plurality of text embeddings 426 with respect to a topic embedding of the plurality of topic embeddings 424.

By way of example, the plurality of topic embeddings 424 can comprise topic embeddings that are associated with restaurant topics (e.g., the quality of meals, a restaurant's decor, and/or the quality of service in a restaurant). The topic embeddings associated with restaurant topics can be compared to a text embedding of the plurality of text embeddings 426 that is associated with a review of a restaurant which is similar to the topic embedding (e.g., restaurant topics). The relevance score for a text embedding that is similar to a particular topic embedding can be higher than a relevance score for another text embedding that is less similar to the same topic embedding. For example, if the text embedding of the plurality of text embeddings 426 was associated with book reviews instead of restaurant reviews, the relevance score would be lower due to book reviews being less relevant to restaurant topics than restaurant reviews. The plurality of relevance scores 432 can be used to configure and/or train one or more multimodal machine-learned models to generate common embeddings in which a plurality of modalities are embedded in an embedding.

Further, a plurality of relevance scores 434 can be generated based on a comparison of the plurality of audio embeddings 428 to the plurality of topic embeddings 424. In some embodiments, the plurality of relevance scores 434 can be based on a dot product of an audio embedding of the plurality of audio embeddings 428 and a topic embedding of the plurality of topic embeddings 424. In some embeddings, the plurality of relevance scores 434 can be based on a Euclidean distance between audio embedding of the plurality of audio embeddings 428 and a topic embedding of the plurality of topic embeddings 424. Further, the plurality of relevance scores 434 can be based on a cosine similarity of an audio embedding of the plurality of audio embeddings 428 with respect to a topic embedding of the plurality of topic embeddings 424.

By way of example, the plurality of topic embeddings 424 can comprise topic embeddings that are associated with literary topics (e.g., reviews of books, analyses of books, and/or analyses of poetry). The topic embeddings associated with literary topics can be compared to an audio embedding of the plurality of audio embeddings 428 that is associated with an audio review of a novel, which is a similar topic to the topic of the topic embedding (e.g., literary topics). The relevance score for an audio embedding that is similar to a particular topic embedding can be higher than a relevance score for another audio embedding that is less similar to the same topic embedding. For example, if the audio embedding of the plurality of audio embeddings 428 was associated with an audio clip of a dog barking instead of literary reviews, the relevance score would be lower due to an audio clip of a dog barking being less relevant to literary topics than a book (e.g., novel) review. The plurality of relevance scores 434 can be used to configure and/or train one or more multimodal machine-learned models to generate common embeddings in which a plurality of modalities are embedded in an embedding.

Further, a plurality of relevance scores 436 can be generated based on a comparison of the plurality of video embeddings 429 to the plurality of topic embeddings 424. In some embodiments, the plurality of relevance scores 436 can be based on a dot product of a video embedding of the plurality of video embeddings 429 and a topic embedding of the plurality of topic embeddings 424. In some embeddings, the plurality of relevance scores 436 can be based on a Euclidean distance between video embedding of the plurality of video embeddings 429 and a topic embedding of the plurality of topic embeddings 424. Further, the plurality of relevance scores 436 can be based on a cosine similarity of a video embedding of the plurality of video embeddings 429 with respect to a topic embedding of the plurality of topic embeddings 424.

For example, the plurality of topic embeddings 424 can comprise topic embeddings that are associated with sports topics (e.g., scores for sports teams, athlete biographies, and/or training tips for various sports). The topic embeddings associated with sports topics can be compared to a video embedding of the plurality of video embeddings 429 that is associated with a discussion of results from a regatta in the sport of rowing which is similar to the topic embedding (e.g., sports topics). The relevance score for a video embedding that is similar to a particular topic embedding can be higher than a relevance score for another video embedding that is less similar to the same topic embedding. For example, if the video embedding of the plurality of video embeddings 429 was associated with a video clip of a pianist playing piano at a concert instead of a discussion about sports, the relevance score would be lower due to a video of a pianist playing piano at a concert being less relevant to sports topics than a discussion of a sporting event. The plurality of relevance scores 436 can be used to configure and/or train one or more multimodal machine-learned models to generate common embeddings in which a plurality of modalities are embedded in an embedding.

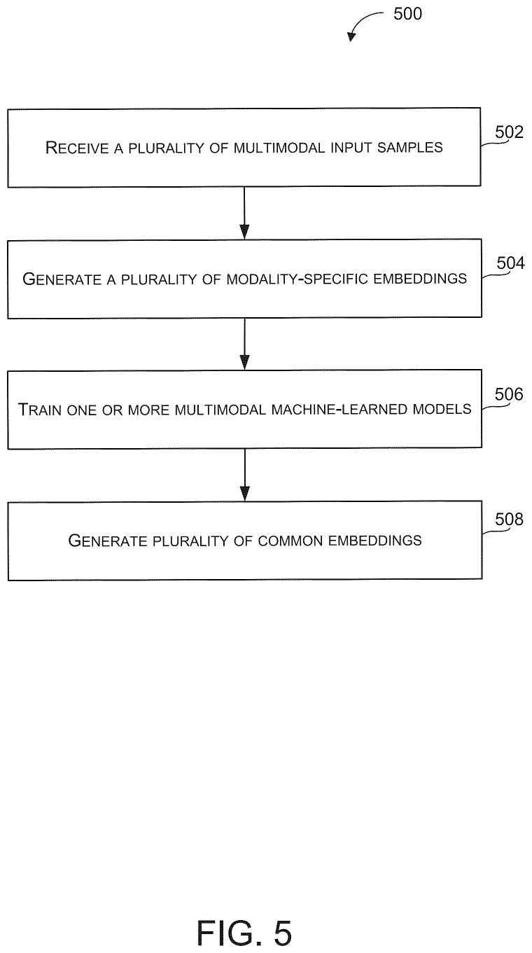

FIG. 5 depicts a flow chart diagram of an example method of generating common embeddings according to example embodiments of the present disclosure. One or more portions of the method 500 can be executed and/or implemented on one or more computing devices or computing systems comprising, for example, the computing device 102, the server computing system 130, the training computing system 150, and/or the computing device 300. Further, one or more portions of the method 500 can be executed or implemented as an algorithm on the hardware devices or systems disclosed herein. FIG. 5 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 502, the method 500 can include receiving a plurality of multimodal input samples associated with a plurality of data modalities and/or a plurality of labels. The plurality of multimodal input samples can comprise a plurality of topics associated with the plurality of multimodal input samples. For example, the plurality of multimodal input samples can comprise a plurality of images associated with a plurality of labels that indicate the content of the plurality of images. Further, a computing system (e.g., the server computing system 130) can receive a plurality of multimodal input samples (e.g., the training data 162) which can comprise image, text segments, audio segments, and/or video segments.

At 504, the method 500 can include generating, based on inputting the plurality of multimodal input samples into a plurality of modality-specific machine-learned models configured to process the plurality of data modalities, a plurality of modality-specific embeddings. Each multimodal input sample of the plurality of multimodal input samples can be inputted into a modality-specific model that is configured to process the data modality associated with the multimodal input sample. Further, the plurality of modality-specific embeddings can comprise a plurality of topic embeddings based on the plurality of topics.

For example, the plurality of multimodal input samples can comprise a plurality of images, a plurality of audio segments, and a plurality of topics. The plurality of images can be inputted into a first modality-specific machine-learned model configured and/or trained to process images, the plurality of audio segments can be inputted into a second modality-specific machine-learned model configured and/or trained to process audio segments, and the plurality of topics can be inputted into a third modality-specific machine-learned model configured and/or trained to process topics. The first modality-specific machine-learned model can generate a plurality of modality-specific embeddings comprising image embeddings, the second modality-specific machine-learned model can generate a plurality of modality-specific embeddings comprising audio segments, and the third modality-specific machine-learned model can generate a plurality of modality-specific embeddings comprising topics. By way of further example, a computing system (e.g., the server computing system 130) can implement the plurality of modality-specific machine-learned models (e.g., the one or more machine-learned models 140), which can receive input comprising the plurality of multimodal input samples (e.g., the training data 162) and generate output comprising the plurality of modality-specific embeddings.

At 506, the method 500 can include training, based on the plurality of modality-specific embeddings, one or more multimodal machine-learned models to generate a plurality of common embeddings. Training the one or more multimodal machine-learned models can comprise modifying a plurality of parameters of the one or more multimodal machine-learned models to minimize a loss associated with a relevance of the plurality of topic embeddings. For example, the server computing system 130 can train one or more multimodal machine-learned models based on the plurality of modality-specific embeddings. The one or more multimodal machine-learned models can be trained over a plurality of iterations. Further, a plurality of parameters of the one or more multimodal machine-learned models can be modified to reduce a loss (e.g., a loss that is associated with a relevance of the plurality of modality-specific embeddings with respect to other modality-specific embeddings associated with a different data modality) that is determined after each of the plurality of iterations. The one or more multimodal machine-learned models can be trained until some threshold accuracy is achieved.

At 508, the method 500 can include generating, based on inputting the plurality of multimodal input samples into the one or more multimodal machine-learned models, the plurality of common embeddings. Generating a plurality of common embeddings can comprise a computing system (e.g., the server computing system 130) implementing the one or more multimodal machine-learned models which can process the plurality of multimodal input samples.

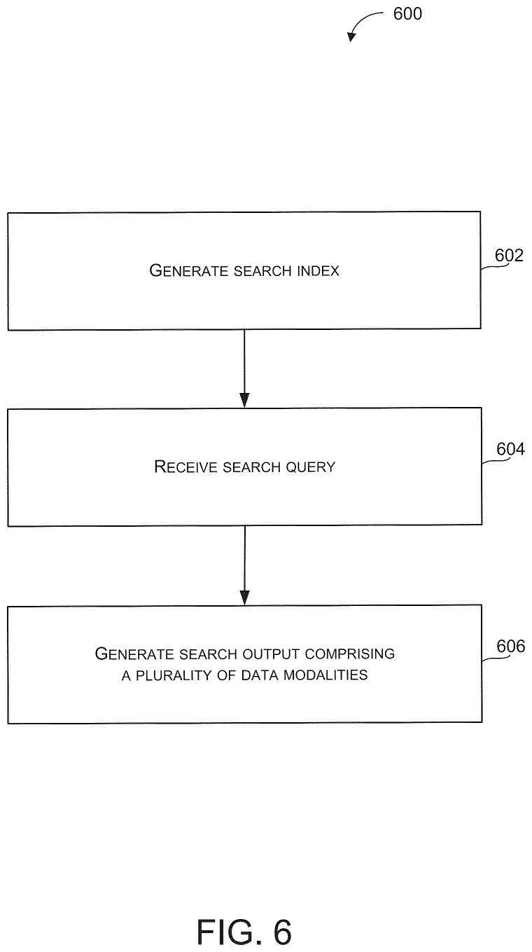

FIG. 6 depicts a flow chart diagram of an example method of generating search output based on a search query according to example embodiments of the present disclosure. One or more portions of the method 600 can be executed and/or implemented on one or more computing devices or computing systems comprising, for example, the computing device 102, the server computing system 130, the training computing system 150, and/or the computing device 300. Further, one or more portions of the method 600 can be executed or implemented as an algorithm on the hardware devices or systems disclosed herein. In some embodiments, one or more portions of the method 600 can be performed as part of the method 500 that is described with respect to FIG. 5. FIG. 6 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include generating, based on the plurality of common embeddings, a search index configured to generate search output associated with one or more of the plurality of data modalities. The search output can comprise one or more images, one or more text segments, one or more audio segments, and/or one or more video segments. For example, the server computing system 130 can implement a nearest neighbor search algorithm (e.g., k-nearest neighbor) that can be used to search the plurality of common embeddings.

At 604, the method 600 can include receiving a search query. For example, the computing device 102 can implement an application that can be used to receive input via a graphical user interface. The input can comprise the search query (e.g., a text-based query comprising a plurality of text segments) from which a common embedding (e.g., a common embedding based on the search query embedding) can be generated. The common embedding based on the search query can then be used to search the plurality of common embeddings.

At 606, the method 600 can include generating search output. The search output can comprise a plurality of results from a plurality of different data modalities. Generating the one or more search outputs can be based on inputting the search query into the one or more multimodal machine-learning models. For example, the server computing system 130 can implement the one or more multimodal machine-learned models and the search query can be inputted into the plurality of multimodal machine-learned models which can generate a common embedding based on the search query. The common embedding based on the search query can then be compared to the plurality of common embeddings to determine the plurality of common embeddings that are similar to the common embedding based on the search query. The server computing system 130 can generate search output comprising a plurality of results based on the plurality of common embeddings that are similar to the common embedding based on the search query.

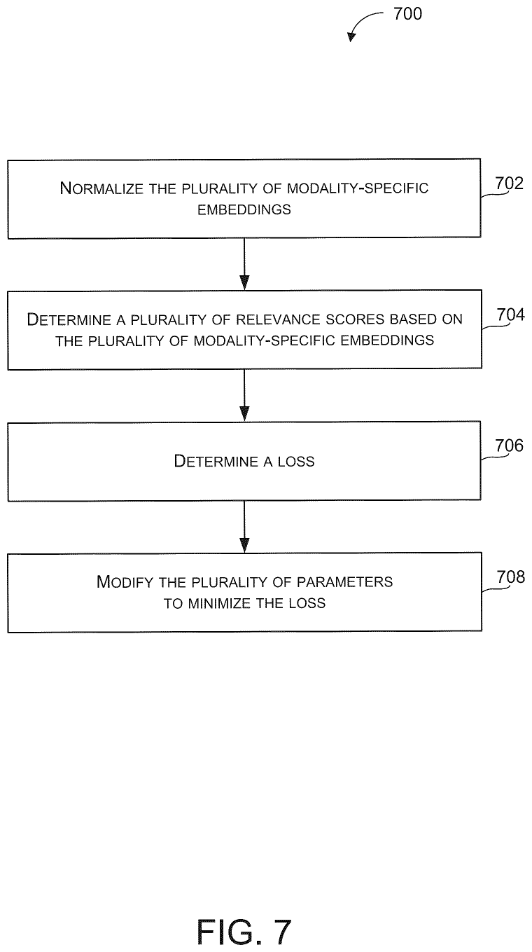

FIG. 7 depicts a flow chart diagram of an example method of training machine-learning models according to example embodiments of the present disclosure. One or more portions of the method 700 can be executed and/or implemented on one or more computing devices or computing systems comprising, for example, the computing device 102, the server computing system 130, the training computing system 150, and/or the computing device 300. Further, one or more portions of the method 700 can be executed or implemented as an algorithm on the hardware devices or systems disclosed herein. In some embodiments, one or more portions of the method 700 can be performed as part of the method 500 that is described with respect to FIG. 5. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include determining, based on inputting the plurality of modality-specific embeddings into the one or more multimodal machine-learned models, a plurality of relevance scores based on comparing the plurality of topic embeddings to the plurality of modality-specific embeddings associated with another one of the plurality of data modalities. For example, the server computing system 130 can implement the one or more multimodal machine-learned models. Based on inputting the plurality of modality-specific embeddings into the one or more multimodal machine-learned models, the one or more multimodal machine-learned models can perform one or more operations and generate a plurality of relevance scores based on comparing the plurality of topic embeddings to the plurality of modality-specific embeddings associated with an image data modality (e.g., images). The plurality of relevance scores can indicate a relevance and/or similarity of one modality-specific embedding with respect to another modality-specific embedding associated with a different data modality.

At 704, the method 700 can include determining a loss based on the plurality of relevance scores. For example, over a plurality of iterations, the server computing system 130 can determine a loss based on the magnitude of the plurality of relevance scores. The loss can be inversely correlated with the plurality of relevance scores such that higher relevance scores can be associated with a lower loss and lower relevance scores can be associated with a higher loss.

At 706, the method 700 can include modifying the plurality of parameters of the one or more multimodal machine-learned models to minimize the loss. For example, the server computing system 130 can modify the weights of the plurality of parameters such that the weights of the plurality of parameters that contribute to reducing the loss (e.g., the parameters that increase the relevance scores) are increased and/or the weights of the plurality of parameters that contribute to increasing the loss (e.g., the parameters that decrease the relevance scores) are decreased. The plurality of weights of the plurality of parameters can be modified until some threshold loss that corresponds to a high accuracy of the plurality of relevance scores for the plurality of modality-specific embeddings is achieved. A low loss can be associated with the plurality of modality-specific embeddings that are similar being associated with high relevance scores and the plurality of modality-specific embeddings that are not similar being associated with low relevance scores.

Further to the descriptions above, a user may be provided with controls allowing the user to make an election as to both if and/or when systems, programs, or features described herein may enable collection of user information (e.g., a user's images and/or a user's preferences), and if the user is sent content or communications from a server. In addition, certain data may be treated in one or more ways before it is stored or used, so that certain information of a user may be removed. For example, a user's identity may be treated so that certain other information associated with the user's identity may not be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computer-implemented method of generating embeddings, the computer-implemented method comprising:
receiving, by a computing system comprising one or more processors, a plurality of multimodal input samples associated with a plurality of data modalities and a plurality of labels, wherein the plurality of multimodal input samples comprise a plurality of topics associated with the plurality of multimodal input samples;
generating, by the computing system, based on inputting the plurality of multimodal input samples into a plurality of modality-specific machine-learned models configured to process the plurality of data modalities, a plurality of modality-specific embeddings, wherein each multimodal input sample of the plurality of multimodal input samples is inputted into a modality-specific model that is configured to process the data modality associated with the multimodal input sample, and wherein the plurality of modality-specific embeddings comprise a plurality of topic embeddings based on the plurality of topics;
training, by the computing system, based on the plurality of modality-specific embeddings, one or more multimodal machine-learned models to generate a plurality of common embeddings, wherein the training comprises modifying a plurality of parameters of the one or more multimodal machine-learned models to minimize a loss associated with a relevance of the plurality of topic embeddings; and
generating, by the computing system, based on inputting the plurality of multimodal input samples into the one or more multimodal machine-learned models, the plurality of common embeddings.

2. The computer-implemented method of claim 1, wherein the plurality of modality-specific machine-learned models comprise a plurality of transformer models that are configured to generate the plurality of modality-specific embeddings based on the plurality of multimodal input samples.

3. The computer-implemented method of claim 1, wherein the plurality of multimodal input samples comprise a plurality of images, a plurality of text segments, a plurality of audio segments, or a plurality of video segments.

4. The computer-implemented method of claim 1, wherein the plurality of modality-specific machine-learned models comprise a topic encoder that is configured to generate the plurality of topic embeddings based on the plurality of topics.

5. The computer-implemented method of claim 1, wherein the plurality of multimodal input samples comprise a plurality of images, wherein the plurality of modality-specific machine-learned models comprise an image encoder that is configured to generate a plurality of image embeddings based on detecting or recognizing visual features of the plurality of multimodal input samples comprising the plurality of images, and wherein the plurality of modality-specific embeddings comprise the plurality of image embeddings.

6. The computer-implemented method of claim 1, wherein the plurality of multimodal input samples comprise a plurality of text segments, wherein the plurality of modality-specific machine-learned models comprise a text encoder that is configured to generate a plurality of text embeddings based on detecting or recognizing semantic features of the plurality of multimodal input samples comprising the plurality of text segments, and wherein the plurality of modality-specific embeddings comprise the plurality of text embeddings.

7. The computer-implemented method of claim 1, wherein the plurality of multimodal input samples comprise a plurality of audio segments, wherein the plurality of modality-specific machine-learned models comprise an audio encoder that is configured to generate a plurality of audio embeddings based on detecting or recognizing audio features of the plurality of multimodal input samples comprising the plurality of audio segments, and wherein the plurality of modality-specific embeddings comprise the plurality of audio embeddings.

8. The computer-implemented method of claim 1, wherein the plurality of multimodal input samples comprise a plurality of video segments, wherein the plurality of modality-specific machine-learned models comprise a video encoder that is configured to generate a plurality of video embeddings based on detecting or recognizing video features of the plurality of multimodal input samples comprising the plurality of video segments, and wherein the plurality of modality-specific embeddings comprise the plurality of video embeddings.

9. The computer-implemented method of claim 1, further comprising:
generating, by the computing system, based on the plurality of common embeddings, a search index configured to generate search output associated with one or more of the plurality of data modalities, wherein the search output comprises one or more images, one or more text segments, one or more audio segments, or one or more video segments.

10. The computer-implemented method of claim 9, further comprising:
receiving, by the computing system, a search query; and
generating, by the computing system, the search output based on comparing the search query to the search index, wherein the search output is associated with a plurality of different data modalities.

11. The computer-implemented method of claim 10, wherein the search query comprises a text-based search query, a navigational query, an audio-based query, or an image-based query.

12. The computer-implemented method of claim 1, wherein the training, by the computing system, based on the plurality of modality-specific embeddings, one or more multimodal machine-learned models to generate a plurality of common embeddings, wherein the training comprises modifying a plurality of parameters of the one or more multimodal machine-learned models to minimize a loss associated with a relevance of the plurality of topic embeddings comprises:
normalizing, by the computing system, the plurality of modality-specific embeddings.

13. The computer-implemented method of claim 1, wherein the training, by the computing system, based on the plurality of modality-specific embeddings, one or more multimodal machine-learned models to generate a plurality of common embeddings, wherein the training comprises modifying a plurality of parameters of the one or more multimodal machine-learned models to minimize a loss associated with a relevance of the plurality of topic embeddings with respect to the plurality of modality-specific embeddings associated with a data modality not comprising the plurality of topic embeddings comprises:
determining, by the computing system, based on inputting the plurality of modality-specific embeddings into the one or more multimodal machine-learned models, a plurality of relevance scores based on comparing the plurality of topic embeddings to the plurality of modality-specific embeddings associated with another one of the plurality of data modalities;
determining, by the computing system, the loss based on the plurality of relevance scores; and
modifying, by the computing system, the plurality of parameters of the one or more multimodal machine-learned models to minimize the loss.

14. The computer-implemented method of claim 1, wherein the plurality of multimodal input samples are generated by a plurality of machine-learned input sample generation models comprising a plurality of domain-specific machine-learned models, and wherein the plurality of machine-learned input sample generation models are configured to generate the plurality of labels and a plurality of confidence scores associated with the plurality of multimodal input samples.

15. One or more tangible non-transitory computer-readable media storing computer-readable instructions that when executed by one or more processors cause the one or more processors to perform operations, the operations comprising:
receiving a plurality of multimodal input samples associated with a plurality of data modalities and a plurality of labels, wherein the plurality of multimodal input samples comprise a plurality of topics associated with the plurality of multimodal input samples;
generating, based on inputting the plurality of multimodal input samples into a plurality of modality-specific machine-learned models configured to process the plurality of data modalities, a plurality of modality-specific embeddings, wherein each multimodal input sample of the plurality of multimodal input samples is inputted into a modality-specific model that is configured to process the data modality associated with the multimodal input sample, and wherein the plurality of modality-specific embeddings comprise a plurality of topic embeddings based on the plurality of topics;
training, based on the plurality of modality-specific embeddings, one or more multimodal machine-learned models to generate a plurality of common embeddings, wherein the training comprises modifying a plurality of parameters of the one or more multimodal machine-learned models to minimize a loss associated with a relevance of the plurality of topic embeddings; and
generating, based on inputting the plurality of multimodal input samples into the one or more multimodal machine-learned models, the plurality of common embeddings.

16. The one or more tangible non-transitory computer-readable media of claim 15, wherein the plurality of multimodal input samples comprise a plurality of images, wherein the plurality of modality-specific machine-learned models comprise an image encoder that is configured to generate a plurality of image embeddings based on detecting or recognizing visual features of the plurality of multimodal input samples comprising the plurality of images, and wherein the plurality of modality-specific embeddings comprise the plurality of image embeddings.

17. The one or more tangible non-transitory computer-readable media of claim 15, wherein the one or more multimodal machine-learned models comprise one or more large language models (LLMs).

18. A computing system comprising:
one or more processors;
one or more non-transitory computer-readable media storing instructions that when executed by the one or more processors cause the one or more processors to perform operations comprising:
receiving a plurality of multimodal input samples associated with a plurality of data modalities and a plurality of labels, wherein the plurality of multimodal input samples comprise a plurality of topics associated with the plurality of multimodal input samples;
generating, based on inputting the plurality of multimodal input samples into a plurality of modality-specific machine-learned models configured to process the plurality of data modalities, a plurality of modality-specific embeddings, wherein each multimodal input sample of the plurality of multimodal input samples is inputted into a modality-specific model that is configured to process the data modality associated with the multimodal input sample, and wherein the plurality of modality-specific embeddings comprise a plurality of topic embeddings based on the plurality of topics;
training, based on the plurality of modality-specific embeddings, one or more multimodal machine-learned models to generate a plurality of common embeddings, wherein the training comprises modifying a plurality of parameters of the one or more multimodal machine-learned models to minimize a loss associated with a relevance of the plurality of topic embeddings; and
generating, based on inputting the plurality of multimodal input samples into the one or more multimodal machine-learned models, the plurality of common embeddings.

19. The computing system of claim 18, wherein the plurality of multimodal input samples comprise a plurality of images, wherein the plurality of modality-specific machine-learned models comprise an image encoder that is configured to generate a plurality of image embeddings based on detecting or recognizing visual features of the plurality of multimodal input samples comprising the plurality of images, and wherein the plurality of modality-specific embeddings comprise the plurality of image embeddings.

20. The computing system of claim 18, wherein the one or more multimodal machine-learned models comprise one or more large language models (LLMs).
